(19) United States
(12) Patent Application Publication
(10) Pub. No.: US 2023/0251362 A1
(43) Pub. Date: Aug. 10, 2023

(54) METHOD OF REMOVING INTERFERENCE AND ELECTRONIC DEVICE PERFORMING THE METHOD

(71) Applicant: SAMSUNG ELECTRONICS CO., LTD., Suwon-si (KR)

(72) Inventors: Sehyun CHO, Suwon-si (KR); Jongmin Yoon, Suwon-si (KR)

(73) Assignee: SAMSUNG ELECTRONICS CO., LTD., Suwon-si (KR)

(21) Appl. No.: 18/132,150

(22) Filed: Apr. 7, 2023

(30) Foreign Application Priority Data
Jan. 11, 2022 (KR) 10-2022-0004098
Apr. 28, 2022 (KR) 10-2022-0052495

(51) Int. Cl. G01S 7/497; G01S 7/487; G01S 7/4865; G01S 17/10

(52) U.S. Cl. CPC G01S 7/497; G01S 7/4873; G01S 7/4865; G01S 17/10

(57) ABSTRACT

An electronic device includes: a light emitter to emit light to an external object at an outside of the electronic device, based on a period of a time frame; a light receiver to detect reflected light of the light; a counter to identify a plurality of counts for the plurality of cells. Each count indicates a number of pulses being generated at least based on a time instance to detect the reflected light by the light receiver. The electronic device also includes a processor and a memory electrically connected to the processor and configured to store instructions executable by the processor, which is configured to determine whether interference is present at least based on a number of cells of which the counts have same values; and then, change a setting of the time frame to prevent or reduce the interference.

### CROSS-REFERENCE TO RELATED APPLICATIONS

This application is a bypass continuation application of International Application No. PCT/KR2023/000093 designating the United States, filed on Jan. 3, 2023, in the Korean Intellectual Property Receiving Office and claiming priority to Korean Patent Application No. 10-2022-0004098, filed on Jan. 11, 2022, and Korean Patent Application No. 10-2022-0052495, filed on Apr. 28, 2022, in the Korean Intellectual Property Office, the disclosures of which are incorporated by reference herein in their entireties.

### BACKGROUND

### 1. Field

The disclosure relates to a method of removing interference and an electronic device performing the method.

### 2. Description of Related Art

A Lidar system may perform three-dimensional (3D) space recognition and head/hand tracking using a light emitter using a laser and a diffractive optical element (DOE) and a light receiver including a photo detector array. The light emitter and the light receiver may operate according to periodic frames.

The light emitter may emit light, and the photo detector array of the light receiver may detect the light reflected from an external object. A distance to an object may be calculated according to time of flight (ToF) of the light using a time at which the light is detected for each cell of the light detector array.

In order to remove or reduce interference by an external light source, light emitting pulses having a set irregular predetermined pattern may be continuously emitted, and a pattern of continuous pulses of a received signal may be compared.

Through correlation analysis between the pulse pattern of the received signal and the light emitting pattern, it may be possible to reduce interference caused by interference pulses of an external light source.

### SUMMARY

According to one embodiment, it may be possible to prevent or reduce interference that may occur in a light receiver that detects reflected light of light emitted from a light emitter when light emitted to an external object at an outside of an external electronic device using a low-illuminance infrared (IR) light-emitting diode (LED) light source or a Lidar system enters the light receiver of the electronic device. According to one embodiment, by removing interference by an external light source using a single pulse, power consumption and a data calculation amount may be reduced compared to a method of removing interference using multiple pulses.

According to one embodiment, an electronic device includes: a light emitter configured to emit light to an external object at an outside of the electronic device, based on a period of a time frame; a light receiver configured to detect reflected light of the light, the reflected light being reflected by the external object and being incident on a plurality of cells in the light receiver, based on the period of the time frame; a counter configured to identify a plurality of counts for the plurality of cells. Each count indicates a number of pulses that is generated based on a time instance to detect the reflected light by the light receiver and a clock frequency of the time frame. The electronic device also includes a processor and a memory electrically connected to the processor and configured to store instructions executable by the processor. The processor is configured to: determine whether interference caused by an external light source is present at least based on a number of cells of which the counts have same values; and change a setting of the time frame to prevent the interference caused by the external light source based on the determination that the interference caused by the external light source is present.

According to one embodiment, a method performed by an electronic device, includes the following steps: emitting light to an outside of the electronic device based on a period of a time frame; detecting reflected light of the light incident on a plurality of cells based on the period of the time frame; identifying a plurality of counts. Each of the plurality of counts indicates a number of pulses in each of the plurality of cells. The pulses is generated based on a time instance to detect the reflected light and a clock frequency of the time frame. The steps also includes: determining whether interference caused by an external light source is present based on a number of cells of which the counts have same values; and changing a setting of the time frame to prevent the interference based on the determination that the interference caused by the external light source is present.

According to one embodiment, an electronic device includes: a light emitter configured to emit light to an outside of the electronic device based on a period of a time frame; a light receiver including a plurality of cells configured to detect reflected light of the light emitted from the light emitter; a timer configured to measure a plurality of time periods. Each of the plurality of time periods indicates a time instance from a start time point that the light is emitted from the light emitter to an end time point that the reflected light is incident on the each of the plurality of cells, based on a clock of the time frame. The electronic device also includes a processor configured to: determine whether interference caused by an external light source is present based on a number of cells among the plurality of cells, in which same time instances are measured by the timer; and change the period of time frame or the start time point based on the determination that the interference caused by the external light source is present.

According to one embodiment, an electronic device includes: a light emitter configured to emit light to an external object at an outside of the electronic device, based on a period of a time frame; a light receiver configured to detect reflected light of the light, the reflected light being reflected by the external object and being incident on a plurality of cells in the light receiver; a counter configured to identify a plurality of counts for the plurality of cells. Each count indicates a number of pulses corresponding to a time lapse from a first time instance that the light emitter emits the light to the external object to a second time instance that the light receiver detects the reflected light; a processor; and a memory electrically connected to the processor and configured to store instructions executable by the processor. The processor is configured to: determine whether interference toward the reflected light is present at least based on a number of cells that have same or substantially similar values of the counts; and change a setting of the time frame to reduce the interference based on the determination that the interference toward the reflected light is present.

According to one embodiment described herein, use of a single pulse may reduce power consumption and the amount of data calculation and remove interference caused by light emitted from an external electronic device compared to a system using multiple pulses.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 illustrates an electronic device in a network environment according to one embodiment;

FIG. 2 illustrates a structure of a wearable electronic device according to one embodiment;

FIG. 3 illustrates an operation of an electronic device to change settings of frames of a light emitter and light receiver according to one embodiment;

FIG. 4 illustrates a method of removing interference by changing a setting of a frame according to one embodiment;

FIG. 5 illustrates a method of removing interference by changing a frame period or a frame start time point according to one embodiment;

FIG. 6 illustrates a plurality of cells of a light receiver according to one embodiment;

FIG. 7 illustrates operations of a light emitter and a light receiver when interference caused by external light emitted from an external light source is present according to one embodiment;

FIG. 8 illustrates an operation of an electronic device to change a frame start time point according to one embodiment;

FIG. 9 illustrates operations of a light emitter and a light receiver when interference caused by external light emitted from an external light source is present according to one embodiment;

FIG. 10 illustrates an operation of an electronic device to change a frame period according to one embodiment; and

FIG. 11 illustrates an operation of an electronic device to change a frame period and a frame start time point according to one embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

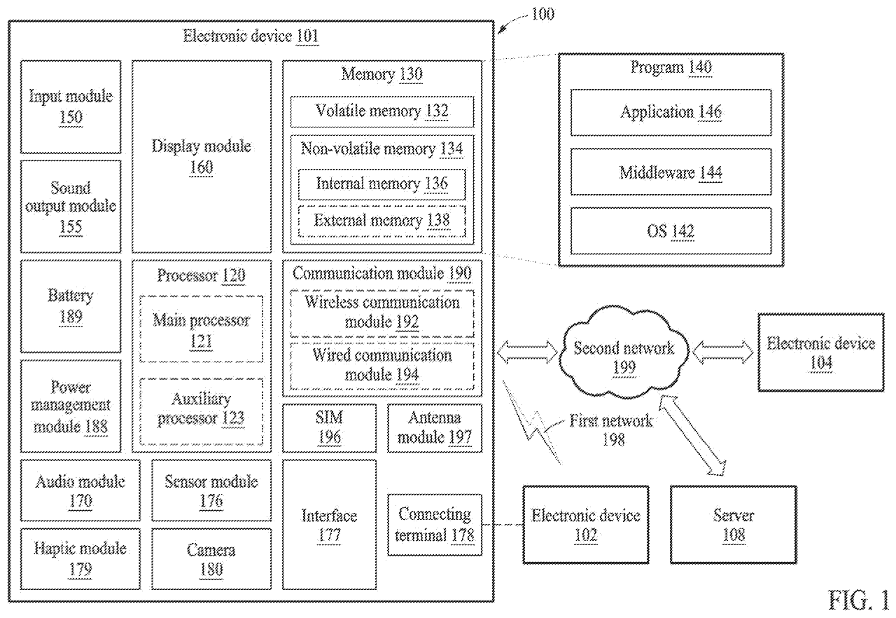

FIG. 1 is a block diagram illustrating an electronic device 101 in a network environment 100 according to one embodiment.

Referring to FIG. 1, the electronic device 101 in the network environment 100 may communicate with an electronic device 102 via a first network 198 (e.g., a short-range wireless communication network), or communicate with an electronic device 104 or a server 108 via a second network 199 (e.g., a long-range wireless communication network). According to one embodiment, the electronic device 101 may communicate with the electronic device 104 via the server 108. According to one embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera 180, a power management module 188, a battery 189, a communication module 190, a subscriber identification module (SIM) 196, or an antenna module 197. In some embodiments, at least one (e.g., the connecting terminal 178) of the components may be omitted from the electronic device 101, or one or more other components may be added to the electronic device 101. In some embodiments, some (e.g., the sensor module 176, the camera 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to one embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to one embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to one embodiment, the auxiliary processor 123 (e.g., an ISP or a CP) may be implemented as a portion of another component (e.g., the camera 180 or the communication module 190) that is functionally related to the auxiliary processor 123. According to one embodiment, the auxiliary processor 123 (e.g., an NPU) may include a hardware structure specifically for artificial intelligence (AI) model processing. An AI model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but examples of which are not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside the electronic device 101 (e.g., a user). The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a record. The receiver may be used to receive an incoming call. According to one embodiment, the receiver may be implemented separately from the speaker or as a part of the speaker.

The display module 160 may visually provide information to the outside of the electronic device 101 (e.g., a user). The display module 160 may include, for example, a display, a hologram device, or a projector and control circuitry to control a corresponding one of the display, the hologram device, and the projector. According to one embodiment, the display device 160 may include a touch sensor adapted to sense a touch, or a pressure sensor adapted to measure an intensity of a force incurred of the touch.

The audio module 170 may convert a sound into an electric signal or vice versa. According to one embodiment, the audio module 170 may obtain the sound via the input module 150 or output the sound via the sound output module 155 or an external electronic device (e.g., an electronic device 102, such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to one embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to one embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to one embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus, which may be recognized by a user via their tactile sensation or kinesthetic sensation. According to one embodiment, the haptic module 179 may include, for example, a motor, a piezoelectric element, or an electric stimulator.

The camera 180 may capture a still image and moving images. According to one embodiment, the camera 180 may include one or more of lenses, image sensors, ISPs, and flashes.

The power management module 188 may manage power supplied to the electronic device 101. According to one embodiment, the power management module 188 may be implemented as, for example, at least a part of a power management integrated circuit (PMIC).

The battery 189 may supply power to at least one component of the electronic device 101. According to one embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more of CPs that are operable independently from the processor 120 (e.g., an AP) and that support direct (e.g., wired) communication or wireless communication. According to one embodiment, the communication module 190 may include a wireless communication module 192 (e.g., a cellular communication module, a short-range wireless communication module, or a global navigation satellite system (GNSS) communication module) or a wired communication module 194 (e.g., a local region network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide region network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to one embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside of the electronic device 101 (e.g., the external electronic device). According to one embodiment, the antenna module 197 may include an antenna including a radiating element including a conductive material or a conductive pattern formed in or on a substrate (e.g., a printed circuit board (PCB)). According to one embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to one embodiment, another component (e.g., a radio frequency integrated circuit (RFIC)) other than the radiating element may be additionally formed as a part of the antenna module 197.

According to one embodiment, the antenna module 197 may form a mmWave antenna module. According to one embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) there between via an inter-peripheral communication scheme (e.g., a bus, general purpose input and output (GPIO), serial peripheral interface (SPI), or mobile industry processor interface (MIPI)).

According to one embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to one embodiment, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a response to the request. To that end, cloud computing, distributed computing, mobile edge computing (MEC), or client-server computing technology may be used, for example. The electronic device 101 may provide ultra-low-latency services using, e.g., distributed computing or MEC. In one embodiment, the external electronic device 104 may include an Internet-of-things (IoT) device. The server 108 may be an intelligent server using machine learning and/or a neural network. According to one embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

For example, each of the external electronic devices 102 and 103 may be a device of the same type as or a different type from the electronic device 101. According to one embodiment, all or some of operations to be executed by the electronic device 101 may be executed by one or more of the external electronic devices (e.g., the electronic device 102 and 103 or a server 108 of FIG. 1). For example, if the electronic device 101 needs to perform a function or a service automatically, or in response to a request from a user or another device, the electronic device 101, instead of, or in addition to, executing the function or the service, may request one or more external electronic devices to perform at least portion of the function or the service. The one or more of external electronic devices receiving the request may perform the at least part of the function or service, or an additional function or an additional service related to the request, and may transfer an outcome of the performing to the electronic device 101. The electronic device 101 may provide the result, with or without further processing of the result, as at least part of a response to the request. For example, the external electronic device 102 may render content data executed by an application and then transmit the data to the electronic device 101, and the electronic device 101 receiving the data may output the content data to the display module. If the electronic device 101 detects a motion of a user through an inertial measurement unit (IMU) sensor, and the like, the processor of the electronic device 101 may correct the rendered data received from the external electronic device 102 based on information on the motion and output the corrected data to the display module. Alternatively, the processor may transmit the information on the motion to the external electronic device 102 and send a rendering request such that screen data is updated accordingly. According to one embodiment, the external electronic device 102 may be one of various types of electronic devices such as a smartphone or a case device that may store and charge the electronic device 101.

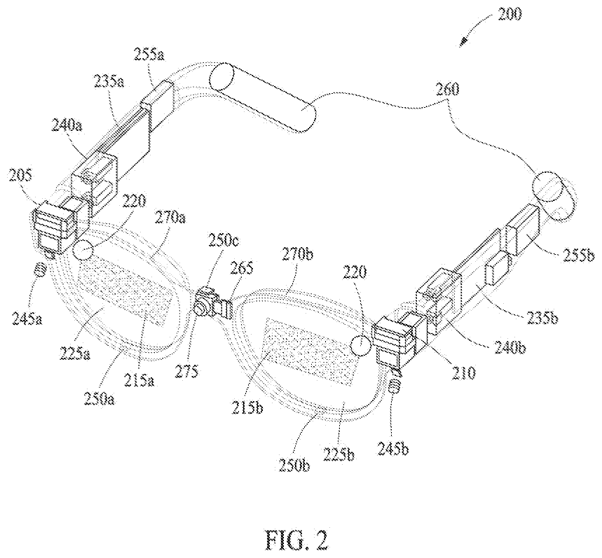

FIG. 2 illustrates a structure of a wearable electronic device 200 (e.g., the electronic device 101 of FIG. 1) according to one embodiment.

Referring to FIG. 2, the wearable electronic device 200 may be worn on a face of a user to provide an image associated with an AR service and/or a virtual reality service to the user.

In one embodiment, the wearable electronic device 200 may include a first display 205, a second display 210, a screen display portion 215, an input optical member 220, a first transparent member 225a, a second transparent member 225b, lighting units 230a and 230b, a first PCB 235a, a second PCB 235b, a first hinge 240a, a second hinge 240b, first cameras 245a and 245b, a plurality of microphones (e.g., a first microphone 250a, a second microphone 250b, and a third microphone 250c), a plurality of speakers (e.g., a first speaker 255a, and a second speaker 255b), a battery 260, second cameras 265 and 275, and visors 270a and 270b.

In one embodiment, a display (e.g., the first display 205 and the second display 210) may include, for example, a liquid crystal display (LCD), a digital mirror device (DMD), or a liquid crystal on silicon (LCoS), an organic light-emitting diode (OLED), a micro light-emitting diode (micro LED), or the like. Although not shown, when the display is one of an LCD, a DMD, and an LCoS, the wearable electronic device 200 may include a light source configured to emit light to a screen output area of the display. In one embodiment, when the display is capable of generating light by itself, for example, when the display is either an OLED or a micro-LED, the wearable electronic device 200 may provide a virtual image with a relatively high quality to the user even though a separate light source is not included. For example, when the display is implemented as an OLED or a micro-LED, a light source may be unnecessary, which may lead to lightening of the wearable electronic device 200. Hereinafter, a display capable of generating light by itself may be referred to as a “self-luminous display”, and it can be assumed that relevant descriptions are referring to a self-luminous display.

The electronic device 200 may include the display, the first transparent member 225a and/or the second transparent member 225b. A user may use the electronic device while wearing the electronic device on his or her face. The first transparent member 225a and/or the second transparent member 225b may be formed of a glass plate, a plastic plate, or a polymer, and may be transparently or translucently formed.

According to one embodiment, the first transparent member 225a may be disposed to face a right eye of the user, and the second transparent member 225b may be disposed to face a left eye of the user. According to one embodiment, when the display is transparent, the display may be disposed to face the user's eyes to configure the screen display portion 215.

A display (e.g., the first display 205 and the second display 210) according to one embodiment may include at least one micro-LED. For example, the micro-LED may express red (R), green (G), and blue (B) by emitting light by itself, and a single chip may implement a single pixel (e.g., one of R, G, and B pixels) because the micro-LED is relatively small in size (e.g., 100 μm or less). Accordingly, the display may provide a high resolution without a backlight unit (BLU), when the display is composed of a micro-LED.

However, the example embodiments are not limited thereto. A pixel may include R, G and B, and a single chip may be implemented by a plurality of pixels including R, G, and B pixels.

In one embodiment, the display (e.g., the first display 205 and the second display 210) may be composed of a display area made up of pixels for displaying a virtual image, and light-receiving pixels (e.g., photo sensor pixels) that receive the light reflected from eyes disposed among pixels, convert the reflected light into electrical energy, and output light.

In one embodiment, the wearable electronic device 200 (e.g., the processor 120 of FIG. 1) may detect a gaze direction (e.g., a movement of a pupil) of the user through the light receiving pixels. For example, the wearable electronic device 200 may detect and track a gaze direction of the right eye of the user and a gaze direction of the left eye of the user through one or more light-receiving pixels of the first display 205 and one or more light-receiving pixels of the second display 210. The wearable electronic device 200 may determine a central position of a virtual image according to the gaze directions (e.g., directions in which pupils of the right eye and the left eye of the user gaze).

In one embodiment, light emitted from the display (e.g., the first display 205 and the second display 210) may reach the screen display portion 215 formed on the first transparent member 225a that faces the right eye of the user, and the screen display portion 215 formed on the second transparent member 225b that faces the left eye of the user, by passing through a lens and a waveguide. For example, the light emitted from the display (e.g., the first display 205 and the second display 210) may be reflected from a grating area formed on the input optical member 220 and the screen display portion 215 to be delivered to the use's eyes, passing through a waveguide.

In one embodiment, a lens may be disposed on a front surface of the display (e.g., the first display 205 and the second display 210). The lens may include a concave lens and/or a convex lens. For example, the lens may include a projection lens or a collimation lens.

In one embodiment, the screen display portion 215 or the transparent member (e.g., the first transparent member 225a and the second transparent member 225b) may include a lens including a waveguide and a reflective lens.

In one embodiment, the waveguide may function to transmit a light source generated by the display to the user's eyes. In one embodiment, the waveguide may be formed of glass, plastic, or a polymer, and may have a nanopattern formed on one inside surface or one outside surface, for example, a grating structure of a polygonal or curved shape. According to one embodiment, light incident to one end of the waveguide may be propagated inside a display waveguide by the nanopattern to be provided to the user. In one embodiment, a waveguide including a free-form prism may provide incident light to the user through a reflection mirror. The waveguide may include at least one of diffractive elements (e.g., a diffractive optical element (DOE) or a holographic optical element (HOE) or at least one of a reflective elements (e.g., a reflection mirror). In one embodiment, the waveguide may guide light emitted from the first display 205 and the second display 210 to the user's eyes, using at least one diffractive element or a reflective element included in the waveguide.

According to one embodiment, the diffractive element may include the input optical member 220 and/or an output optical member. For example, the input optical member 220 may be an input grating area, and the output optical member may be an output grating area. The input grating area may play a role as an input terminal which diffracts (or reflects) the light output from the display (e.g., the first display 205 and the second display 210) (e.g., a micro LED) to transmit the light to a transparent member (e.g., the first transparent member 225a and the second transparent member 225b) of the screen display portion 215. The output grating region may serve as an exit for diffracting (or reflecting), to the user's eyes, the light transmitted to the transparent members (e.g., the first transparent member 250a and the second transparent member 250b) of the waveguide.

According to one embodiment, the reflective element may include a total reflection optical element or a total reflection waveguide for total internal reflection (TIR). For example, TIR, which is one of schemes for inducing light, may form an angle of incidence such that light (e.g., a virtual image) entering through the input grating area is completely reflected from one surface (e.g., a specific surface) of the waveguide, to completely transmit the light to the output grating area.

In one embodiment, the light emitted from the displays 205 and 210 may be guided by the waveguide through the input optical member 220. Light traveling in the waveguide may be guided toward the eyes of the user through the output optical member. The screen display portion 215 may be determined based on the light emitted toward the user's eyes.

In one embodiment, the first cameras 245a and 245b may include a camera used for 3 degrees of freedom (3DoF), head tracking of 6DoF, hand detection and tracking, gestures and/or space recognition. For example, the first cameras 245a and 245b may include a GS camera to detect a movement of a head or a hand and track the movement.

For example, a stereo camera may be applied to the first cameras 245a and 245b for head tracking and space recognition, and a camera with the same standard and performance may be applied. A GS camera having excellent performance (e.g., image dragging) may be used for the first cameras 245a and 245b to detect a minute movement such as a quick movement of a hand or a finger and to track the movement.

According to one embodiment, a rolling shutter (RS) camera may be used for the first cameras 245a and 245b. The first cameras 245a and 245b may perform a SLAM function through space recognition and depth capturing for 6 DoF. The first cameras 245a and 245b may perform a user gesture recognition function.

In one embodiment, the second cameras 265 and 275 may perform a SLAM function and a gesture function through space recognition and depth capturing for 6 DoF. For example, the light emitter 265 may emit light to the front (e.g., in a 7 o'clock direction in FIG. 2) of the electronic device 200. The light receiver 275 may receive reflected light of the light emitted from the light emitter 265.

For example, the light emitter 265 may include a laser and a DOE to emit the light. The light receiver 275 may include a photo detector array to detect the incident reflected light. The light emitter 265 and the light receiver 275 may operate according to periodic frames.

In one embodiment, at least one sensor (e.g., a gyro sensor, an acceleration sensor, a geomagnetic sensor, a touch sensor, an illuminance sensor and/or a gesture sensor) and the first cameras 245a and 245b may perform at least one of the functions among head tracking for 6DoF, pose estimation and prediction, gesture and/or space recognition, and a simultaneous localization and mapping (SLAM) through depth imaging. In one embodiment, the first camera 245a and 245b may be classified and used as a camera for head tracking or a camera for hand tracking.

In one embodiment, the lighting units 230a and 230b may be used differently according to positions in which the light units 230a and 230b are attached. For example, the lighting units 230a and 230b may be attached together with the first cameras 245a and 245b mounted around a hinge (e.g., the first hinge 240a and the second hinge 240b that connects a frame and a temple or around a bridge that connects frames. If capturing is performed using a GS camera, the lighting units 230a and 230b may be used to supplement a surrounding brightness. For example, the lighting units 230a and 230b may be used in a dark environment or when it is not easy to detect a subject to be captured due to mixing of various light sources and reflected light.

In one embodiment, components (e.g., the processor 120 and the memory 130 in FIG. 1) constituting the wearable electronic device 200 may be disposed in a PCB (e.g., the first PCB 235a and the second PCB 235b). The PCB may transmit electrical signals to the components constituting the wearable electronic device 200. For example, the PCBs 235a and 235b may be disposed on temples, and transmit an electrical signal to each module (e.g., a camera, a display, audio, and a sensor) and another PCB through a flexible PCB (FPCB).

According to one embodiment, at least one PCB may include a first board, a second board, and an interposer disposed between the first board and the second board. In one embodiment, a plurality of microphones (e.g., the first microphone 250a, the second microphone 250b, and the third microphone 250c) may convert an external acoustic signal into electrical audio data. The electrical audio data may be variously utilized according to a function (or an application being executed) being performed by the wearable electronic device 200.

In one embodiment, a plurality of speakers (e.g., the first speaker 255a and the second speaker 255b) may output audio data that is received from a communication circuit (e.g., the communication circuit 210 in FIG. 2) or stored in a memory (e.g., the memory 220 in FIG. 2). In one embodiment, one or more batteries 260 may be included, and may supply power to the components constituting the wearable electronic device 200.

In one embodiment, the visors 270a and 270b may adjust a transmittance amount of external light incident on the user's eyes according to a transmittance. The visors 270a and 270b may be positioned in front or behind the screen display portion 215. The front side of screen display portion 215 may refer to a direction opposite to the user wearing the electronic device 200, and the rear side may refer to a direction of the user wearing the electronic device 200. The visors 270a and 270b may protect the screen display portion 215 and adjust an transmittance amount of external light.

For example, the visors 270a and 270b may include an electrochromic element that changes color according to applied power to adjust a transmittance. Electrochromism is a phenomenon in which an applied power triggers an oxidation-reduction reaction to change color. The visors 270a and 270b may adjust a transmittance of external light, using the color change of the electrochromic element. For example, the visors 270a and 270b may include a control module and an electrochromic element. The control module may control the electrochromic element to adjust a transmittance of the electrochromic element.

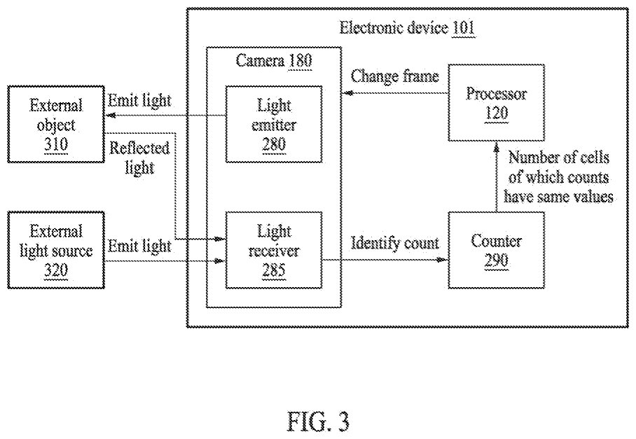

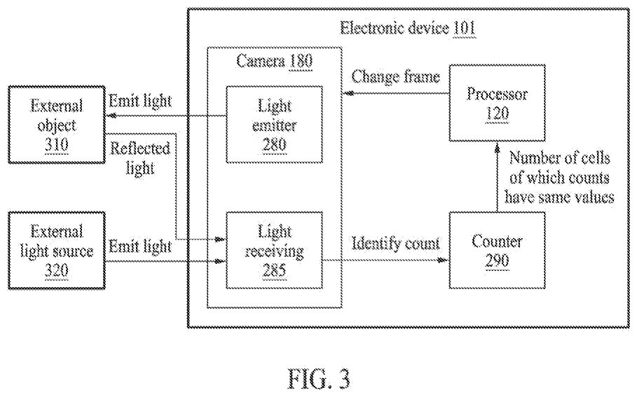

FIG. 3 illustrates an operation of the electronic device 101 to change settings of frames of a light emitter 280 and a light receiver 285 according to one embodiment.

Referring to FIG. 3, the electronic device 101 may include one or more cameras (e.g., the camera 180 of FIG. 1 and the second cameras 265 and 275 of FIG. 2), the processor 120, and a counter (e.g., time to digital converter (TDC) 290). The camera may include the light emitter 280 (e.g., the light emitter 265 of FIG. 2) and the light receiver 285 (e.g., the light receiver 275 of FIG. 2).

The processor 120 may control an operation of the camera 180. For example, the processor 120 may control the light emitter 280 and/or the light receiver 285 of the camera to operate based on a time frame. The camera 180 may emit light to an external object 310 in an outside of the electronic device 101 and detect reflected light of the emitted light, which is reflected by the external object.

For example, the light emitter 280 may include a vertical-cavity surface-emitting laser (VCSEL) or a DOE. The VCSEL may be a laser diode that emits light, such as a laser beam, in a direction perpendicular to an upper surface. The DOE may disperse and emit the light emitted from the VCSEL. For example, the DOE may disperse and emit the light emitted from the VCSEL to the front (e.g., in a 7 o'clock direction, which is a gaze direction of a user in FIG. 2) of the electronic device 101.

The light receiver 285 may detect the reflected light. The light emitted from the light emitter 280 may be reflected from the external object 310, and the light receiver 285 may detect the reflected light reflected from the external object 310. For example, the light receiver 285 may include a single photon avalanche diode (SPAD) array. The SPAD array may include a plurality of cells. Each of the plurality of cells may detect the reflected light by generating an electrical signal in response to the reflected light being incident on the light receiver 285 (e.g., incident on the plurality of cells of the light receiver 285).

The light emitter 280 and/the light receiver 285 may operate according to the time frame. For example, when a frame rate is set to 30 frames per second (fps), the light emitter 280 may emit the light about every 0.033 seconds, and the light receiver 285 may detect the reflected light for about 0.033 seconds whenever the light emitter 280 emits the light.

The TDC 290 may count a number of clocks corresponding to a time point at which the light is incident on the light receiver 285 based on an operating frequency or a clock frequency. For example, the TDC 290 may count the number of clocks when the light is emitted from the light emitter 280 based on the operating frequency. The number of clocks identified by the TDC 290 may be a number of pulses generated according to the operating frequency.

The TDC 290 may identify a count corresponding to each of the plurality of cells. That is, the TDC 290 may identify a plurality of counts for the plurality of cells. For example, the count may be the number of pulses generated when the reflected light is detected in a cell. For example, the plurality of cells of the light receiver 285 may include cell a, cell b, cell c, and cell d, and the TDC 290 may identify the number of pulses generated when the reflected light is detected in each of the cells a, b, c, and d. For example, a pulse according to the clock frequency in the TDC 290 when light is detected in cell a, may be a 10th pulse, and the TDC 290 may identify that a count corresponding to cell a is 10. For example, the count identified by the TDC 290 may be the number of pulses generated according to the clock frequency during a time lapse from a first time instance that the light is emitted from the light emitter 280 to a second time instance that the reflected light is incident on the light receiver 285.

The TDC 290 may convert the time period from the first time instance to the second time instance into the count. For example, the clock frequency of the TDC 290 may be 1 gigahertz (GHz), a time elapsing from the first time instance at which the light is emitted from the light emitter 280 to the second time instance at which the reflected light is detected in cell a may be 10 nanoseconds (ns), and the TDC 290 may convert the elapsed time 10 ns into a count “10”. The count may be a time, such as time of flight (ToF), elapsing from a time at which the light emitted from the light emitter 280 is reflected from the external object 310 to a time at which the light is detected in each of the plurality of cells.

The light receiver 285 and/or the TDC 290 may operate for a portion of a time of a frame period. When a frame rate is set to 30 fps, a frame period is 0.033 seconds. For example, the light emitter 280 may emit the light every frame period of 0.033 seconds. Over the frame period of 0.033 seconds, the light receiver 285 may detect the light for 0.03 seconds, and the TDC 290 may identify the count for 0.03 seconds.

Depending on a path through which the light emitted from the light emitter 280 is reflected to be incident on the light receiver 285, a time at which the reflected light is detected in each of the plurality of cells may vary. For example, a path of reflected light of light emitted from the electronic device 101, which is reflected from an object far from the electronic device 101 may be longer than a path of reflected light reflected from an object close to the electronic device 101.

As described above, the TDC 290 may measure a time lapse from the first time that the light emitted from the light emitter 280 is reflected from an external object to the second time that the reflected light is incident on the light receiver 285. The TDC 290 may count the measured time lapse in pulses or convert the measured time lapse into the number of pulses.

The processor 120 may calculate or determine a distance to the external object 310 using the identified count. For example, the count when the reflected light is detected in the cell a, may be 10, the clock frequency may be 1 GHz, and the processor 120 may identify the distance to the external object 310 using speed of light and the count. The count “10” may mean that a time it takes for the light emitted from the light emitter 280 to reach cell a is 10 ns. The processor 120 may calculate or determine a distance between the electronic device 101 and the external object 310 positioned at a location corresponding to cell by using the speed of light and the time lapse.

The TDC 290 may operate based on a time frame. For example, in response to the light being emitted from the light emitter 280, the TDC 290 may identify a count during a corresponding frame period. For example, when a frame rate is 30 fps, the TDC 290 may identify a count for about 0.033 seconds in response to the light being emitted from the light emitter 280.

As illustrated in FIG. 3, the light receiver 285 may detect the reflected light of the light emitted from the light emitter 280, which is reflected from the external object 310. In addition, the light receiver 285 may detect external light emitted from an external light source 320. For example, the light receiver 285 may detect the external light emitted from the external electronic device 101, such as a low-illuminance IR LED light source and a Lidar system. When the external light is detected in the electronic device 101, interference caused by the external light source 320 may be present.

The processor 120 may determine whether interference is present by the external light source 320 based on a number of cells that having the same values of their respective counts. Please note that, throughout the present disclose, the “same” values of the counts are not limited to exact, same numerical values, such as 10, 10, 10, 10. Herein, the “same” values of the counts also indicate substantially same or similar values (such as, 9, 10, 11, 12 or 8, 11, 13, 15). For example, the processor may determine that the counts are the “same” when differences of their respective count values are less than a predetermined (threshold) value(s).

In response to the light emitted from the external light source 320 being detected in the plurality of cells of the light receiver 285, the TDC 290 may identify that the counts for the plurality of cells have the same values. Unlike the reflected light of the light emitted from the light emitter 280, the external light may not have a path difference caused by reflection of light. The plurality of cells may detect the external light at a same time, and the TDC 290 may identify the counts having the same values corresponding to the plurality of cells. The processor 120 may determine whether the interference caused by the external light source 320 is present by comparing the number of cells of which the counts have the same values with a threshold value.

For example, in response to the number of cells of which the counts have the same values being greater than or equal to a predetermined number of cells, the processor 120 may determine that the interference caused by the external light source 320 is present. For example, in response to the number of cells of which the counts have the same value being greater than or equal to the set number of cells “n”, the processor 120 may determine that the interference caused by the external light source 320 is present.

As another example, in response to the number of cells of which the counts have the same value being greater than or equal to a predetermined percentage, the processor 120 may determine that the interference caused by the external light source 320 is present. For example, in response to the number of cells of which the counts have the same values being greater than or equal to 50% of the total number of cells, the processor 120 may determine that the interference caused by the external light source 320 is present. A percentage may be variously set to, for example, 60% and 70%.

The processor 120 may change a setting of a frame to prevent or reduce the interference caused by the external light source 320. For example, the processor 120 may change a period (length) of the frame period or delay a frame start time point of the frame.

The light emitter 280 may include a light emitter that emits light to the external object 310 of the outside the electronic device 101. For example, the light emitter may emit the light to the outside the electronic device 101 time period based on a time frame or a predetermined time period. The light receiver 285 may include a cell that detects the reflected light of the light emitted from the light emitter 280.

The electronic device 101 may include a timer. For example, the timer may measure a time lapse (e.g., ToF) from when the light is emitted from the light emitter 280 until the reflected light is incident on the light receiver 285. For example, the light receiver 285 may include the plurality of cells. The timer may measure a time it takes for the light to be detected in each of the plurality of cells.

For example, the timer may measure the time lapse based on a clock operating frequency. For example, the timer may measure the time lapse using a first clock when the light is emitted from the light emitter 280 and a second clock when the light is detected in each of the cells of the receiving module 285.

The processor 120 may determine whether the interference caused by the external light source 320 is present based on the number of cells in which same amounts of the time lapses are measured by the timer among the plurality of cells. For example, in response to the number of cells in which the same amount of time is measured being greater than or equal to the set number of cells, the processor 120 may determine that the interference caused by the external light source 320 is present. For example, in response to the number of cells in which the same amount of time is measured being greater than or equal to a set percentage, the processor 120 may determine that the interference caused by the external light source 320 is present.

The processor 120 may calculate a distance between the electronic device 101 and the external object 310 corresponding to each of the cells according to a time measured by the timer. For example, a large amount of time measured by the timer in a cell may indicate that the electronic device 101 and the external object 310 positioned at a location corresponding to the cell are a long distance apart.

The processor 120 of the electronic device 101 may change a time period in which the light emitter 280 emits the light or a start time point at which the light emitter 280 emits the light, based on the determination whether the interference caused by the external light source is present. For example, in response to a determination that the interference caused by the external light source 320 is present based on the number of cells in which the same amounts of time lapses are measured by the timer, the processor 120 may change (a length of) the time period in which the light emitter 280 emits the light or the start time point of the time period at which the light emitter 280 emits the light.

The processor 120 may calculate a period of the external light source 320 according to a period in which the timer measures the same amount of time in at least one cell. The processor 120 may change the time period in which the light emitter 280 emits the light or the start time point at which the light emitter 280 emits the light based on the period of the external light source 320.

For example, in response to the period of the external light source 320 being the same as the time period in which the light emitter 280 emits the light, the processor 120 may change the time period to a period different from the period of the external light source 320 or advance or delay the start time point at which the light emitter 280 emits the light.

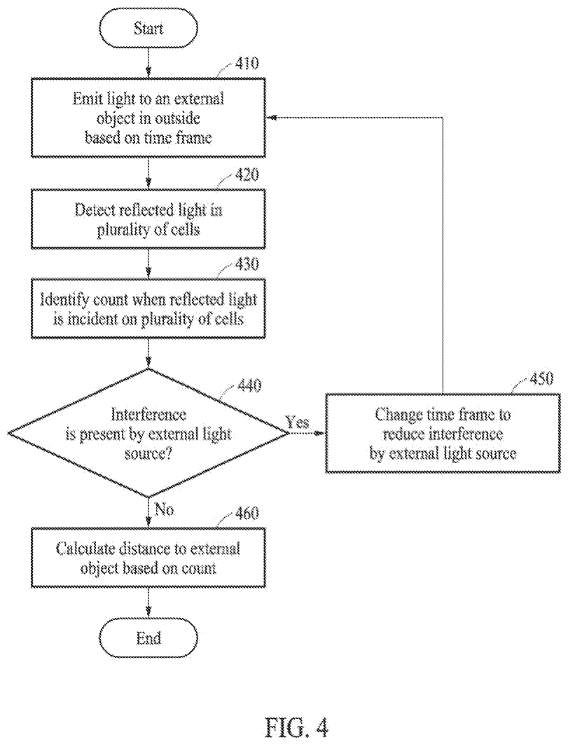

FIG. 4 illustrates a method of removing or reducing interference according to one embodiment.

Referring to FIG. 4, in operation 410, an electronic device (e.g., the electronic device 101 of FIG. 1 or the electronic device 200 of FIG. 2) may emit light to an external object 310 in an outside of the electronic device 101 based on a time frame. The electronic device 101 may emit the light through a light emitter (e.g., the light emitter 280 of FIG. 3) for each frame.

In operation 420, the electronic device 101 may detect reflected light in a plurality of cells of a light receiver (e.g., the light receiver 285 of FIG. 3). For example, the light receiver 285 may include a SPAD array, and the SPAD array may detect the reflected light. The reflected light detected in the plurality of cells may be the light emitted from the light emitter 280 and incident on the light receiver 285.

In operation 430, the electronic device 101 may identify a count when the reflected light is incident on the plurality of cells. For example, a TDC (e.g., the TDC 290 of FIG. 3) of the electronic device 101 may identify the count using a number of pulses or clocks at a time point at which the reflected light is detected by the light receiver 285 based on a clock frequency. The count may be the number of pulses according to the clock frequency during a time from when the light is emitted from the light emitter 280 until the reflected light is incident on the plurality of cells.

The count may be an output obtained by converting the time it takes for the reflected light to be incident on the plurality of cells. For example, if the clock frequency is 1 GHz and 10 pulses are generated according to the clock frequency until the reflected light is incident on cell a, a time it takes for the reflected light to be incident on cell a is 10 ns, and the TDC 290 may identify that a count of the cell a is “10”. The count of cell a “10” may be an output obtained by converting the time 10 ns it takes for the reflected light to be incident on cell “a” into the number of generated pulses.

Each of the plurality of cells may generate an electrical signal in response to the reflected light being incident on the plurality of cells, and the TDC 290 may identify the number of pulses to be generated until a time point at which the electrical signal is generated in a cell.

In operation 440, the electronic device 101 may determine whether the interference caused by an external light source (e.g., the external light source 320 of FIG. 3) is present. The plurality of cells of the light receiver 285 may detect the reflected light of the light emitted from the light emitter 280 and/or external light generated by the external light source 320. In response to the external light being incident on the light receiver 285, the TDC 290 may identify that counts of all or some of the plurality of cells have “same” values. Please note that, throughout the present disclose, the “same” values of the counts are not limited to exact same numerical values, for example, 10, 10, 10, and 10. Herein, the “same” values of the counts also indicate substantially same or similar values (for example, 9, 10, 11, and 12 or 8, 11, 13, and 15). For example, the processor may determine that the counts are the “same” when differences of their respective count values are less than a predetermined (threshold) value(s).

For example, the electronic device 101 may determine whether the interference caused by the external light source 320 is present based on a number of cells of which counts have the “same” values. For example, the electronic device 101 may determine whether the interference caused by the external light source 320 is present by comparing the number of cells of which the counts have the “same” value with a threshold value.

For example, in response to the number of cells of which the counts have the same values being greater than or equal to a set percentage, the processor 120 may determine the interference caused by the external light source 320 is present. The interference caused by the external light source 320 may indicate that the external light emitted from the external light source 320 is incident on the light receiver 285.

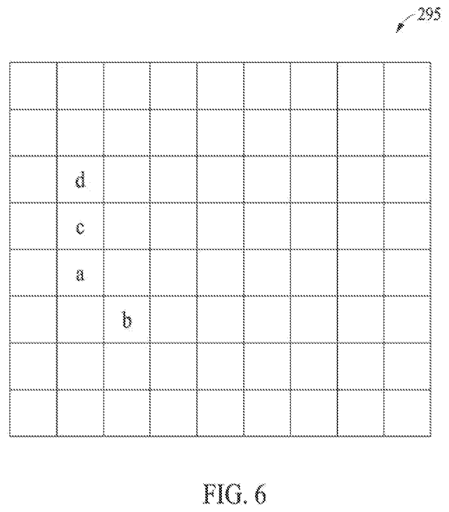

As another example, the electronic device 101 may determine whether the interference caused by the external light source is present based on locations of cells of which counts have the same values. When a user wears the electronic device 101 described above in FIG. 2, an object at a close distance may be generally positioned at a lower end based on a plurality of cells configured as shown in FIG. 6 to be described later. A count identified in a cell corresponding to the location of the object nearby may have a small value.

When the cells of which the counts have the same values are positioned at the lower end among the plurality of cells and the same count value is greater than a threshold value, the electronic device 101 may determine that the interference caused by the external light source 320 is present. When the cells of which the counts have the same values are positioned at an upper end among the plurality of cells and the same count values are less than the threshold value, the electronic device 101 may determine the interference caused by the external light source is present.

In the above-mentioned example, the threshold value to be compared with the count value may be determined based on a distance. For example, in response to the distance being 1 meter (m), a count “n” identified from an object positioned at a distance of 1 m may be set as the threshold value. In the above-mentioned example, the upper and lower ends of the plurality of cells may be areas divided into upper and lower ends with respect to a cell positioned in a center of the plurality of cells illustrated in FIG. 6 to be described later. The electronic device 101 may determine whether the interference caused by the external light source 320 is present based on a difference between the values of the counts of the cells of which the counts have the same values and a value of a count of a cell within a distance to the cells of which the counts have the same value. For example, when identifying cell a, cell b, cell c, and cell d of which counts have the same values, the electronic device 101 may compare a value of a count of a cell within a distance adjacent to the cells a through d with the value of the counts of the cells a through d.

For example, in response to the respective differences between the value of the counts of the cells a through d and each of counts values of other cells within a distance, which are adjacent to the cells a through d, is greater than or equal to a difference, the electronic device 101 may determine that the interference caused by the external light source 320 is present. The electronic device 101 may determine whether the interference caused by the external light source 320 is present using an average of the respective differences between the value of the counts of the cells of which the counts have the same value and each of the values of the counts of the cells within the distance adjacent to the cells of which the counts have the same value.

A count may be construed as a distance to an external object. The counts identified in the cells adjacent to the cells having the same count values may have similar values. In response to the respective differences between the value of the counts of the cells of which the counts have the same value and each of the values of the counts measured in the cells adjacent to the cells having the same count values being large, it may be understood that the interference caused by the external light source 320 is present.

As another example, the electronic device 101 may determine whether the interference caused by the external light source 320 is present based on locations of cells in which same amounts of time lapses are measured by a timer. A description of the operation of the electronic device 101 to determine whether the interference caused by the external light source 320 is present based on the locations of the cells having the same count values may apply to an operation of the electronic device 101 to determine whether the interference caused by the external light source 320 is present based on locations of cells in which the same amounts of time lapses are measured by the timer in the substantially same manner.

As another example, the electronic device 101 may determine whether the interference caused by the external light source 320 is present using a time of cells in which the same amounts of time lapses are measured by the timer and a time measured in a cell within a distance to the cells in which the same amounts of time lapses are measured by the timer. For example, in response to a difference between the time lapse of the cells in which the same amounts of time are measured by the timer and the time lapse measured in another cell within the distance to the cells in which the same amount of time is measured by the timer being greater than a threshold value, the electronic device 101 may determine that the interference caused by the external light source 320 is present.

In response to the determination of operation 440 that the interference caused by the external light source is present, the electronic device 101 may change a setting of a time frame in operation 450. For example, the setting of the time frame may be a period (a length) of the time frame or a start time point of the time frame. For example, the processor (e.g., the processor 120 of FIG. 1) may change at least one of the frame period or the frame start time point to prevent or reduce the interference caused by the external light source 320.

In operation 460, optionally, in response to the determination of operation 440 that the interference caused by the external light source 320 is not present, the electronic device 101 may calculate a distance to the external object 310. For example, the processor 120 may calculate the distance to the external object 310 based on a count. For example, when the clock frequency is 1 GHz, a count of cell a is “10”, and a count of cell b is “20”, a distance between a location corresponding to cell a and the external object 310 may be calculated at 1.5 m, and a distance between a location corresponding to cell b and the external object 310 may be calculated at 3 m. For example, the distance between the location corresponding to cell a and the external object 310 may be calculated by dividing a distance in half, the distance obtained by multiplying speed of light by a time of 10 ns calculated in accordance with the count.

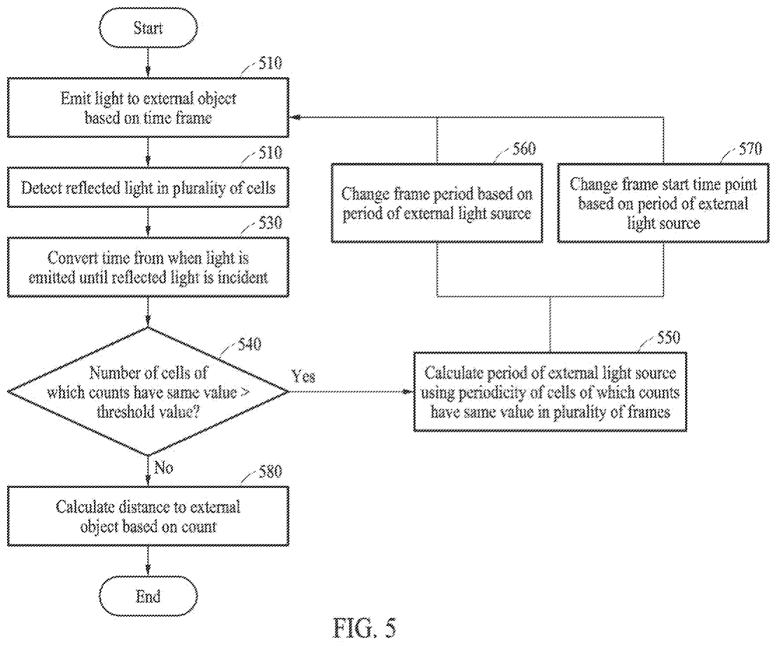

FIG. 5 illustrates a method of removing interference by changing a frame period or a frame start time point according to one embodiment. Referring to FIG. 5, in operation 510, an electronic device (e.g., the electronic device 101 of FIG. 1) may emit light to an external object 310 in an outside of the electronic device 101 based on a time frame. In operation 520, the electronic device 101 may detect reflected light in a plurality of cells.

Descriptions of operations 410 and 420 of FIG. 4 respectively, may be applied to the above-mentioned operations 510 and 520 in the substantially same manner.

In operation 530, the electronic device 101 may convert a time lapse from when light is emitted until the reflected light is incident on a cell into a count. For example, an electrical signal may be generated when the reflected light is detected in each of the plurality of cells. The TDC 290 (e.g., the TDC 290 of FIG. 3) may identify a number of pulses corresponding to the time lapse. For example, the TDC 290 of the electronic device 101 may identify the count using the number of pulses or clocks at a time point at which the reflected light is detected in the light receiver 285 based on a clock frequency. For example, when the number of pulses corresponding to the time lapse in cell a is “10”, the electronic device 101 may identify that the count of cell a is “10”.

The electronic device 101 may also identify a time (e.g., ToF) for the time lapse by multiplying a reciprocal of the clock frequency by the count. For example, when the count of cell a is “10” and the clock frequency is 1 GHz, the electronic device 101 may calculate that a time it takes for the reflected light to be incident on cell a is 10 ns. As described above, the count of each of the cells may be a time elapsed until the reflected light is incident on each of the cells.

In operation 540, the electronic device 101 may determine whether interference caused by the external light source 320 is present. For example, the electronic device 101 may determine whether a number of cells of which counts have a same value is greater than or equal to a threshold value. For example, a threshold value may be the set number of cells or a set percentage. If the number of cells of which the counts have the same values is greater than or equal to the threshold value, the electronic device 101 may determine that the interference caused by the external light source is present. A description of operation 440 of FIG. 4 may be applied to operation 540 in the substantially same manner.

In operation 550, the electronic device 101 may calculate or determine a period of the external light source (e.g., the external light source 320 of FIG. 3). The electronic device 101 may identify cells of which counts have the same values in a plurality of frames. The electronic device 101 may calculate or determine the period of the external light source 320 using a period in which the cells of which the counts have the same values are identified.

In operation 560, the electronic device 101 may change a frame period based on the calculated or determined period of the external light source 320. For example, the electronic device 101 may change a frame period of the light emitter 280 and the light receiver 285, such as by changing a time frame rate of 30 fps to 60 fps or 15 fps.

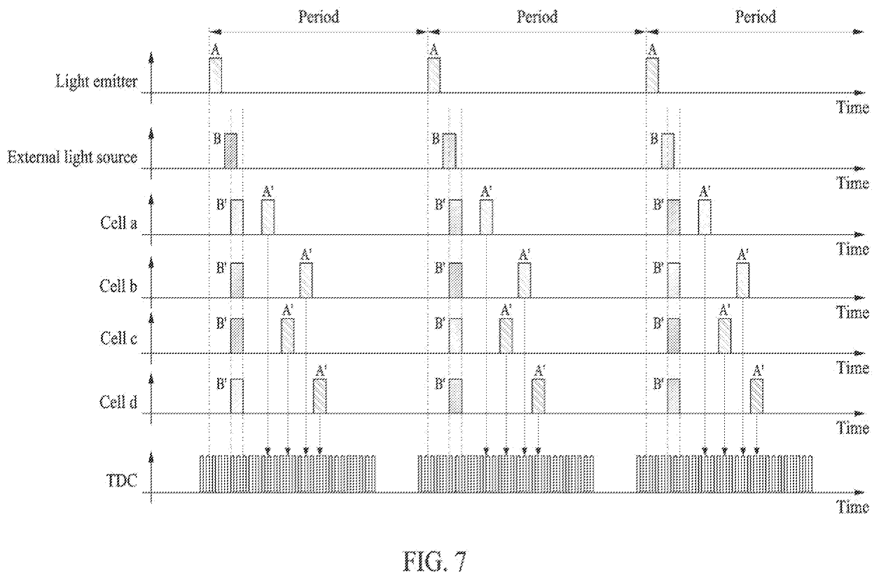

In operation 570, alternatively or in addition, the electronic device 101 may change a frame start time point of the time frame based on the calculated or determined period of the external light source 320. For example, the electronic device 101 may change frame start time points of the light emitter 280 and the light receiver 285 by time t. For example, the electronic device 101 may control the light emitter 280, the light receiver 285, and/or the TDC 290 according to frames by delaying or advancing a frame start time point by time t. Operation of the electronic device 101 to change a frame setting in operation 560 and 570 are described with reference to FIGS. 7 through 11. In operation 580, optionally, the electronic device 101 may calculate or determine a distance to the external object 310 based on the count.

FIG. 6 illustrates a plurality of cells 295 of a light receiver (e.g., the light receiver 285 of FIG. 3) according to one embodiment.

The light receiver 285 may include the plurality of cells 295 as shown in FIG. 6. Each of the plurality of cells 295 may identify incident reflected light. An electronic device (e.g., the electronic device 101 of FIG. 1; a counter in the electronic device 101) may identify a count when the reflected light is detected in a cell and calculate a distance to the external object 310 using the count. Each of the plurality of cells may correspond to an external location. For example, the electronic device 101 may emit light forward (e.g., in a 7 o'clock direction of FIG. 2) and detect reflected light reflected from the external object 310. A location of an external environment may correspond to a location of each of the cells in front of the electronic device 101. The location of each of the plurality of cells 295 may be the location of the external environment. For example, an external environment corresponding to cell “a” may be positioned below an external environment corresponding to cell “c.”

Hereinafter, cell a, cell b, cell c, and cell d shown in FIGS. 7 through 11 may be cell a, cell b, cell c, and cell d shown in FIG. 6, respectively.

FIGS. 7 through 11 are diagrams illustrating operations of an electronic device (e.g., electronic device 101 of FIG. 1) to change a (time) frame period′ or a (time) frame start point′ according to one embodiment.

FIG. 7 illustrates operations of a light emitter (e.g., the light emitter 280 of FIG. 3) and a light receiver (e.g., the light receiver 285 of FIG. 3) when interference caused by external light emitted from the external light source 320 is present.

As illustrated in FIG. 7, the light emitter 280, the light receiver 285, and/or the TDC 290 may operate based on a (time) frame rate. For each (time) frame, the light emitter 280 may emit light, the light receiver 285 may detect reflected light, and the TDC 290 may identify a count, which is further explained below.

As illustrated in FIG. 7, the light emitter 280 may emit light A, the light A may be reflected from an external object of the electronic device 101, and reflected light A′ may be incident on a plurality of cells (e.g., the plurality of cells 295 of FIG. 6) of the light receiver 285. The reflected light A′ may be detected in cell a, cell b, cell c, and cell d (e.g., the cells a, b, c, and d of FIG. 6) at a different time point depending on a path, for example, a distance to the external object. In response to the light A being emitted from the light emitter 280, a TDC (e.g., the TDC 290 of FIG. 3) may identify a count when the reflected light A′ is detected in the plurality of cells 295 according to a clock frequency (or a clock operating frequency or a clock).

The plurality of cells 295 of the light receiver 285 may detect external light B emitted from an external light source (e.g., the external light source 320 of FIG. 3). The external light B′ may be incident on cell a, cell b, cell c, and cell d at a same time point. The TDC 290 may identify a plurality of counts in the plurality of cells (cell a, cell b, cell c, and cell d), according to the detected external light B′.

The external light B may be incident on the light receiver 285, the external light B′ may be detected in the plurality of cells, and thus, interference caused by the external light may be present. A processor (e.g., the processor 120 of FIG. 1) of the electronic device 101 may determine whether interference caused by the external light source 320 is present based on a number of counts having the same values in the plurality of cells. FIG. 7 illustrates cell a, cell b, cell c, and cell d of which counts have the same values. This is merely a description of a convenient example, and cells other than cell a, cell b, cell c, and cell d may have counts with the same values according to the external light B.

The electronic device 101 may identify cells of which counts have the same values in a plurality of frames. As illustrated in FIG. 7, the electronic device 101 may identify the cells of which the counts have the same values in three time frames.

The electronic device 101 may calculate a period of the external light source 320 using a time period in which the cells of which the counts have the same value are identified. For example, when cell a, cell b, cell c, and d have counts with the same value “n” in a first frame, a second frame, and a third frame, the electronic device 101 may calculate that the particular period of the external light source 320 may be the same as the time frame period of the light emitter 280 and the light receiver 285.

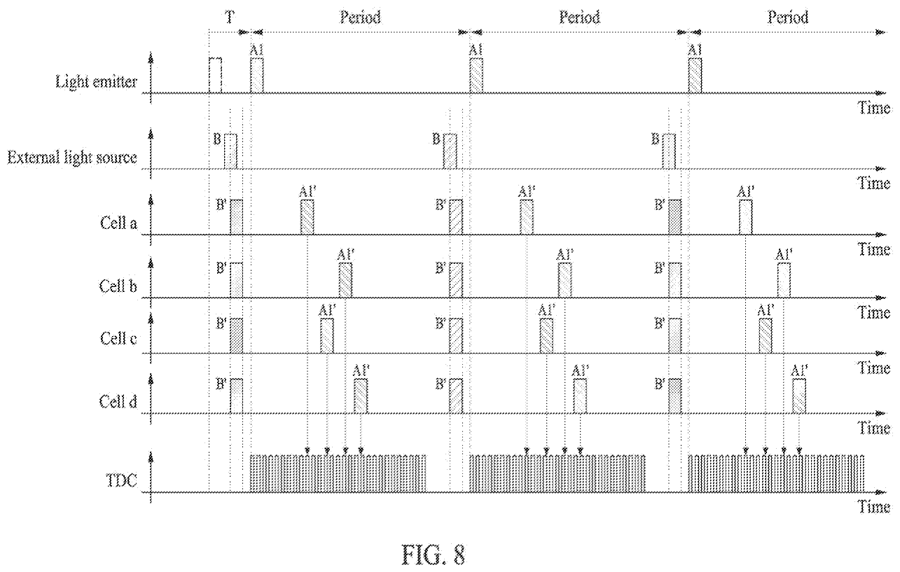

FIG. 8 illustrates an operation of an electronic device (e.g., the electronic device 101 of FIG. 1) to change a frame start time point (or a time frame start point) according to one embodiment. FIG. 8 illustrates an operation of the electronic device 101 to change a frame start time point if interference caused by an external light source (e.g., the external light source 320 of FIG. 3) is present as described in FIG. 7 to prevent or reduce the interference caused by the external light source 320.

As illustrated in FIG. 8, the electronic device 101 may change (or delay) the frame start time point by “T” to remove or reduce the interference caused by the external light source 320. As illustrated in FIG. 8, the light emitter 280 may emit light A1 at a start time point obtained by delaying the original start time point by T, and a plurality of cells of the light receiver 285 may detect reflected light A′. A TDC (e.g., the TDC 290 of FIG. 3) may identify a new count according to a time point at which the reflected light A1′ is detected in each of the plurality of cells.

As illustrated in FIG. 8, a light receiver (e.g., the light receiver 285 of FIG. 3) may not detect external light B′ in response to the external light B′ being incident on the plurality of cells. Because the frame start time point is delayed by T, cells a through d does not detect the external light B′. The electronic device may delay the frame start time point by “T” as illustrated in FIG. 8 based on the period of the external light source 320 calculated in FIG. 7.

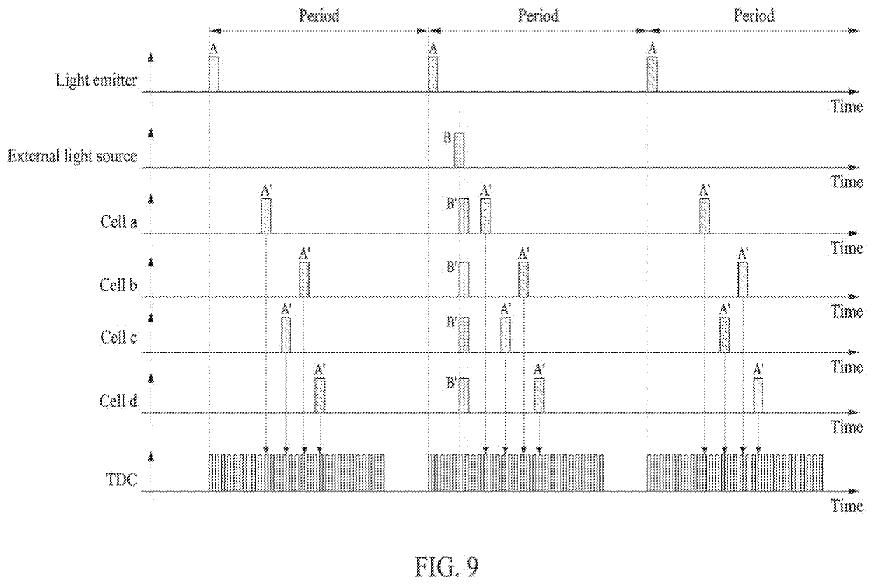

FIG. 9 illustrates operations of a light emitter (e.g., the light emitter 280 of FIG. 3) and a light receiver (e.g., the light receiver 285 of FIG. 3) when interference caused by external light emitted from an external light source (e.g., the external light source 320 of FIG. 3) is present, according to one embodiment. FIG. 7 illustrates an example in which interference caused by external light B is present in all three time frames, while FIG. 9 illustrates an example in which interference caused by external light B is present only in the second frame.

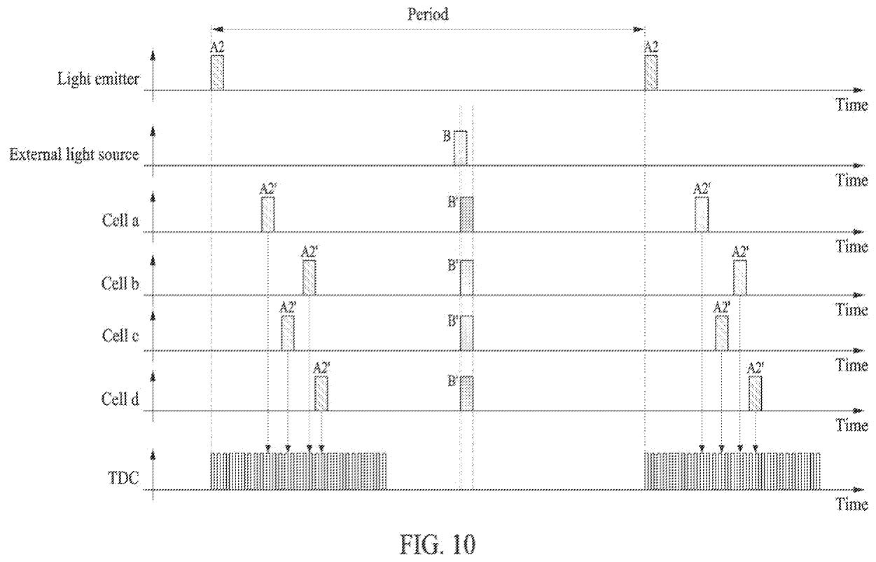

Just as shown in FIG. 8 and explained above, the interference in the second frame may be avoided or reduced by changing (delaying, adjusting) the frame start time point, for example, by a certain time instance, according to one embodiment illustrated in FIG. 10. FIG. 10 illustrates an operation of the electronic device 101 to change a frame period if interference caused by an external light source (e.g., the external light source 320 of FIG. 3) is present as described in FIG. 9 to prevent or reduce interference caused by the external light source 320.

As illustrated in FIG. 10, the electronic device 101 may change (delay or adjust) a time frame period. A frame period of a light emitter (e.g., the light emitter 280 of FIG. 3), a light receiver (e.g., the light receiver 285 of FIG. 3), and/or a TDC (e.g., the TDC 290 of FIG. 3) illustrated in FIG. 10 may be twice as the frame period illustrated in FIG. 9. A frame rate of FIG. 10 may be half a frame rate of FIG. 9. That is, for example, the light emitter 280, the external light source 320, and the TDC 290 illustrated in FIG. 9 may have a frame rate of 30 fps, and the light emitter 280, the external light source 320, and the TDC 290 illustrated in FIG. 10 may have a frame rate of 15 fps.

The electronic device 101 may change the frame period illustrated in FIG. 9 to a frame period such as the frame period illustrated in FIG. 10 to remove or reduce the interference caused by the external light B. The electronic device 101 may emit light A2 through the light emitter 280 and detect reflected light A2′ from the light receiver 285 according to the changed frame period. The electronic device 101 may calculate or determine a period of the external light source 320 when identifying a count obtained by the reflected light A′ and the external light B′ in the same manner as FIG. 9 after a third frame in FIG. 9. The electronic device 101 may change the frame period as shown in FIG. 10 based on the period of the external light source 320, which is calculated or determined by the electronic device 101.

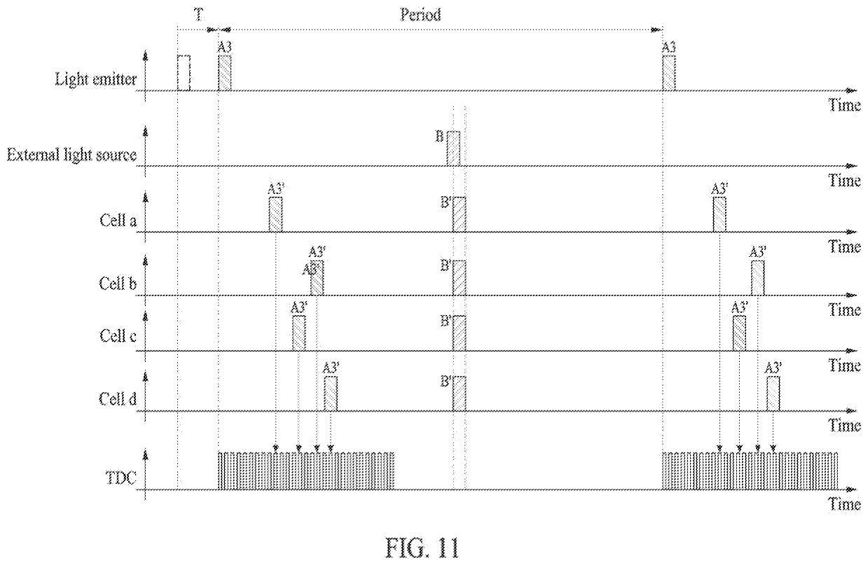

FIG. 11 illustrates an operation of an electronic device (e.g., the electronic device 101 of FIG. 1) to change a frame period and a frame start time point according to one embodiment. The electronic device 101 in FIG. 9 reduces the frame period by half as shown in FIG. 11 and change (delay) the frame start time point by T.

According to one embodiment, an electronic device (e.g., the electronic device 101 of FIG. 1) may include a light emitter (e.g., the light emitter 280 of FIG. 3) configured to emit light to an external object 310 in an outside of the electronic device 101 based on a time frame, a light receiver (e.g., the receiving module 285 of FIG. 3) configured to detect reflected light of the light incident on a plurality of cells based on the time frame, a TDC (e.g., the TDC 290 of FIG. 3) configured to identify a count indicating a number of pulses generated when the reflected light is detected based on a clock frequency according to the time frame, a processor (e.g., the processor 120 of FIG. 1), and a memory (e.g., the memory 130 of FIG. 1) electrically connected to the processor and configured to store instructions executable by the processor, wherein the processor 120 may determine whether interference caused by an external light source (e.g., the external light source 320 of FIG. 3) is present based on a number of cells of which the count has a same value when the instructions are executed and change a setting of the frame to prevent or reduce interference caused by the external light source 320 according to whether interference caused by the external light source 320 is present.

The processor 120 may determine whether interference caused by the external light source 320 is present by comparing the number of cells of which the counts have the same values with a threshold value.

The processor 120 may determine whether interference caused by the external light source 320 is present based on locations of cells of which the counts have the same values.

The processor 120 may determine whether interference caused by the external light source 320 is present based on a difference between the value of the count of the cells of which the counts have the same values and a value of a count of a cell within a distance to the cells of which the counts have the same values.

The processor 120 may identify cells of which the counts have the same values in a plurality of frames and calculate a period of the external light source 320 using a period in which the cells of which the counts have the same values are identified.

The processor 120 may change a period of the frame based on the period of the external light source 320.

The processor 120 may change a start time point of the frame based on the period of the external light source 320.

The processor 120 may calculate a distance between each of locations corresponding to the plurality of cells and an external object 310 based on the count.

According to one embodiment, a method of removing interference may include emitting light to an external object 310 in an outside of the electronic device 101 based on a time frame, detecting reflected light of the light incident on a plurality of cells based on the time frame, identifying a count indicating a number of pulses generated when the reflected light is detected based on a clock frequency based on the time frame, determining whether interference caused by an external light source 320 is present based on a number of cells of which the count has a same value, and changing a setting of the frame to prevent or reduce interference caused by the external light source 320 according to whether interference caused by the external light source is present.

The determining of whether interference is present may include determining whether interference caused by the external light source 320 is present by comparing the number of cells of which the counts have the same values with a threshold value.

The method may further include identifying cells of which the counts have the same values in a plurality of frames and calculating a period of the external light source 320 using a period in which the cells of which the counts have the same values are identified.

The changing of the setting of the frame may include changing a period of the frame based on the period of the external light source 320.

The changing of the setting of the frame may include changing a start time of the frame based on the period of the external light source 320.

According to one embodiment, a method of removing interference may include emitting light to an external object 310 in an outside of the electronic device 101 at a start time point of a time frame, detecting reflected light of the light incident on a plurality of cells based on the time frame based on a clock frequency in response to the light being emitted, converting a time from when the light is emitted until the reflected light is incident on the plurality of cells into a count indicating a number of generated pulses, determining whether interference caused by an external light source 320 is present based on a number of cells of which the count has a same value, calculating a period of the external light source 320 using a periodicity of cells of which the counts have the same values in a plurality of frames, and changing a setting of the frame to prevent or reduce interference caused by the external light source 320 based on the period of the external light source.

The determining of whether interference is present may include determining whether interference caused by the external light source 320 is present by comparing the number of cells of which the counts have the same values with a threshold value.

The changing of the setting of the frame may include changing a period of the frame based on the period of the external light source 320.

According to one embodiment, an electronic device 101 may include a light emitter 280 including at least one light emitter configured to emit light to an external object 310 in an outside of the electronic device 101 according to a time period, a light receiver 285 including at least one cell configured to detect reflected light of the light emitted from the light emitter 280, a timer configured to measure a time from when the light is emitted from the at least one light emitter until the reflected light is incident on the at least one cell based on a clock operating frequency, and a processor 120, wherein the processor 120 may determine whether interference caused by an external light source 320 is present based on a number of cells 295 in which a same amount of time is measured by a timer among the at least one cell 295, and change the time period in which the light emitter 280 emits light or a start time point at which the light emitter 280 emits light according to whether interference caused by the external light source is present.

The processor 120 may determine whether interference caused by the external light source 320 is present based on a difference between a time of the cells 295 in which the same amount of time is measured by the timer and a time measured by the timer in a cell 295 within a distance to the cells in which the same amount of time is measured by the timer.

The processor 120 may calculate a period of the external light source 320 according to a period in which the same amount of time is measured by the timer in the at least one cell 295 and change the time period in which the light emitter 280 emits light or a start time point at which the light emitter 280 emits light based on the period of the external light source 320.

The electronic device according to embodiments may be one of various types of electronic devices. The electronic device may include, for example, a portable communication device (e.g., a smartphone), a computer device, a portable multimedia device, a portable medical device, a camera, a wearable device, or a home appliance device. According to one embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. Terms such as “1^{st}”, “2^{nd}”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example embodiment, the module may be implemented in a form of an application-specific integrated circuit (ASIC).

Embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a light emitter configured to emit light to an external object at an outside of the electronic device, based on a period of a time frame;
a light receiver configured to detect reflected light of the light, the reflected light being reflected by the external object and being incident on a plurality of cells in the light receiver, based on the period of the time frame;
a time to digital counter (TDC) configured to identify a plurality of counts for the plurality of cells, each count indicating a number of pulses being generated based on a time instance to detect the reflected light by the light receiver and a clock frequency; and
a processor; and
a memory electrically connected to the processor and configured to store instructions executable by the processor,
wherein the processor is configured to:
determine whether interference caused by an external light source is present at least based on a number of cells of which the counts have same values when the instructions are executed; and
change a setting of the time frame to reduce the interference caused by the external light source at least based on the determination that the interference caused by the external light source is present.

2. The electronic device of claim 1, wherein the processor is further configured to determine that the cells of which the counts have the same values based on a determination that differences of the counts' values are within a predetermined threshold value.

3. The electronic device of claim 1, wherein the processor is further configured to determine whether the interference caused by the external light source is present by comparing the number of the cells of which the counts have the same values with a threshold value.

4. The electronic device of claim 1, wherein the processor is further configured to determine whether the interference caused by the external light source is present based on locations of cells of which the counts have the same values.

5. The electronic device of claim 1, wherein the processor is further configured to determine whether the interference caused by the external light source is present based on a difference between the counts having the same values and another count of another cell within a distance to the cells of which the counts have the same values.

6. The electronic device of claim 1, wherein the processor is further configured to:
identify the cells of which the counts have the same values in a plurality of the time frames; and
calculate a period of the external light source using periods in which the cells of which the counts have the same values are identified.

7. The electronic device of claim 6, wherein the processor is further configured to change the period of the time frame based on the period of the external light source.

8. The electronic device of claim 6, wherein the processor is further configured to change a start time point of the time frame based on the period of the external light source.

9. The electronic device of claim 1, wherein the processor is further configured to calculate a distance between each of locations corresponding to the plurality of cells and the external object at the outside of the electronic device based on the plurality of counts.

10. A method performed by an electronic device, the method comprising:
emitting light to an outside of the electronic device based on a period of a time frame;
detecting reflected light of the light incident on a plurality of cells based on the period of the time frame;
identifying a plurality of counts, each of the plurality of counts indicating a number of pulses in each of the plurality of cells, the pulses being generated based on a time instance to detect the reflected light and a clock frequency;
determining whether interference caused by an external light source is present based on a number of cells of which the counts have same values; and
changing a setting of the time frame to reduce the interference at least based on the determination that the interference caused by the external light source is present.

11. The method of claim 10, further comprising determining that the cells of which the counts have the same values based on a determination that differences of the counts' values are within a predetermined threshold value.

12. The method of claim 11, wherein the step of determining whether the interference is present based on the number of cells of which the counts have the same values further comprises determining whether the interference caused by the external light source is present by comparing the number of cells of which the counts have the same values with a threshold value.

13. The method of claim 11, further comprising:
identifying cells of which the counts have the same values in a plurality of time frames; and
calculating a period of the external light source using a period in which the cells of which the counts have the same values are identified.

14. The method of claim 13, wherein the step of changing of the setting of the time frame further comprises changing the period of the time frame based on the period of the external light source.

15. The method of claim 13, wherein the step of changing of the setting of the time frame further comprises changing a start time point of the time frame based on the period of the external light source.

16. An electronic device comprising:
a light emitter configured to emit light to an outside of the electronic device based on a period of a time frame;
a light receiver having a plurality of cells configured to detect reflected light of the light emitted from the light emitter;
a timer configured to measure a plurality of time periods, each of the plurality of time periods indicating a time instance from a start time point that the light is emitted from the light emitter to an end time point that the reflected light is incident on the each of the plurality of cells, based on a clock operating frequency; and
a processor,
a memory electrically connected to the processor and configured to store instructions executable by the processor,
wherein the processor is configured to:
determine whether interference caused by an external light source is present based on a number of cells among the plurality of cells, in which same time instances are measured by the timer; and
change the period of time frame or the start time point based on the determination that the interference caused by the external light source is present.

17. The electronic device of claim 16, wherein the processor is further configured to determine whether the interference caused by the external light source is present based on a difference between (i) the same time instances measured for the number of cells among the plurality of cells and (ii) another time instance measured by the timer in another cell within a distance to the cells in which the same time instances measured by the timer.

18. The electronic device of claim 16, wherein the processor is further configured to:
determine a period of the external light source according to the same time instances measured for the number of cells among the plurality of cells; and
change the period of the time frame or a start time point of the time frame based on the period of the external light source.
